(19) United States
(12) Patent Application Publication
(10) Pub. No.: US 2012/0241622 A1
(43) Pub. Date: Sep. 27, 2012

(54) METHOD FOR DETERMINING THE 14C CONTENT OF A GAS MIXTURE AND ARRANGEMENT SUITABLE THEREFOR

(75) Inventors: Karsten Heyne, Grossbeeren (DE); Jens Beckmann, Bremen (DE); Tom Rubin, Berlin (DE)

(73) Assignee: FREIE UNIVERSITAET BERLIN, Berlin (DE)

(21) Appl. No.: 13/392,377

(22) PCT Filed: Aug. 27, 2010
(86) PCT No.: PCT/EP10/05331

§ 371 Date: May 4, 2012

(30) Foreign Application Priority Data
Aug. 28, 2009 (DE) 10 2009 039 051.0
Oct. 7, 2009 (DE) 10 2009 045 458.6

(51) Int. Cl. G01N 21/39; G01N 21/35

(52) U.S. Cl. 250/339.13

(57) ABSTRACT

A method for determining the ¹⁴C content of a gas mixture in which ¹⁴C isotopes are present as molecule constituents, is provided. The gas mixture is provided in a measuring space, wherein infrared laser radiation is supplied to the measuring space as measurement radiation. The laser radiation to be supplied to the measuring space is deflected such that it passes through the measuring space a plurality of times by interacting with the gas mixture, wherein the laser radiation is supplied to a detector, in order to determine the absorption of laser radiation by the gas mixture and therefrom determine the ¹⁴C content. For generating the laser radiation a pulsed laser is used, which as measurement radiation emits laser pulses with a pulse duration of less than 5 μs, which are supplied to the measuring space.

### CROSS-REFERENCE TO A RELATED APPLICATION

This application is a National Phase Patent Application of International Patent Application Number PCT/EP2010/005331, filed on Aug. 27, 2010, which claims priority of German Patent Application Number 10 2009 039 051.0, filed on Aug. 28, 2009, and of German Patent Application Number 10 2009 045 458.6, filed on Oct. 7, 2009.

### BACKGROUND

This invention relates to a method for determining the ¹⁴C content of a gas mixture and to an arrangement suitable therefor.

Such method in particular can be used for determining the age of organic substances by means of the so-called radiocarbon method which utilizes the radioactive decay of the isotope ¹⁴C. This isotope is formed from nitrogen (¹⁴N₂) in the atmosphere by cosmic radiation and is chemically present as ¹⁴CO₂. In their metabolism, living organisms permanently exchange carbon with the atmosphere, so that a defined distribution ratio of the carbon isotopes ¹²C, ¹³C and ¹⁴C is obtained. The concentration of the radioisotope ¹⁴C is about 10⁻¹² times the concentration of ¹²C.

After the death of a living being, the ¹⁴C concentration decreases with a half-life period of 5730 years, since no more metabolism takes place. The quantities of the two stable carbon isotopes ¹²C and ¹³C on the other hand remain constant, so that by determining the ratio of ¹⁴C relative to ¹²C or ¹³C the age of an organic sample can be determined.

Furthermore, fluctuations of the concentration of the carbon isotopes in the atmosphere, for example as a result of ongoing industrialization between 1670 and 1950 and as a result of the uses and atmospheric tests of nuclear weapons between 1943 and 1963, can be utilized for age determinations, for example for determining the time of birth of a human being with reference to the ¹⁴C content in the eye lenses.

Known methods for determining the ¹⁴C content of a sample on the one hand are based on the direct measurement of the radioactive decay, for example by means of a counting tube. Due to the low concentration of ¹⁴C isotopes in organic material, this method has the disadvantage that only a small number of detectable decay events per time unit is available. In particular with smaller organic samples, this method therefore can lead to inaccurate results of the age determination. Other known methods utilize the acceleration mass spectrometry for determining the ¹⁴C/¹²C ratio and/or the ¹⁴C/¹³C ratio of a sample.

The present method on the other hand is based on a determination of the ¹⁴C content of a sample by using infrared laser radiation, after the sample first has been converted into a gas mixture (by chemical reaction) and has been provided in a measuring space, for example in the form of a measuring chamber. By means of the laser radiation as measuring beam the gas mixture provided in the measuring space is irradiated, wherein the laser radiation is deflected, for example by means of reflecting elements, such that it passes through the measuring space a plurality of times by interacting with the gas mixture.

Subsequently, the laser radiation is coupled out from the measuring space and supplied to a detector, in order to determine the absorptivity during interaction of the laser radiation with the gas mixture in a frequency-dependent manner and therefrom determine the ¹⁴C content of the gas mixture (and hence also of the sample to be examined, from which the gas mixture has been generated). This can be effected in particular by measuring an absorption spectrum of the gas mixture, wherein the focus is put on characteristic vibrations of certain molecules containing the ¹⁴C isotope, such as the stretching vibrations in CO₂.

Such method is known from D. Labrie and J. Reid, Appl. Phys. 24, pp. 381 to 386 (1981). An advantage of these laserspectroscopic measuring modules as compared to the determination of the ¹⁴C content by using an acceleration mass spectrometer consists in the lower space requirement and the lower acquisition costs.

### SUMMARY

It is the problem underlying the invention to further improve a method for determining the ¹⁴C content in a gas mixture by using laser radiation.

According to an exemplary embodiment of the invention a pulsed laser is used for generating the laser radiation, which as measuring radiation generates and emits laser pulses with a pulse duration of less than 50 μs, in particular less than 5 μs or even less than 500 ns, which are supplied to the measuring space containing the gas mixture.

The method according to the invention is based on the use of a pulsed laser operating in the infrared range, with which so-called ultrashort laser pulses (with a pulse duration of less than 5 μs or less than 500 ns) are generated, for acting on the gas mixture containing ¹⁴C isotopes, which is present in a measuring space. In this way, high accuracies can be achieved when determining the ¹⁴C content.

In the present case, pulsed laser is understood to be both a classical pulse laser, which intrinsically is designed for generating (ultra)short laser pulses, and a combination of e.g. a continuous-wave laser (CW laser) with additional (external) means for generating such short (coherent) laser pulses, such as a Pockels cell or an acousto-optical modulator.

This means that the laser pulses either can be generated as usual (intrinsically) by a laser in the form of a pulse laser; or a generation of short laser pulses is effected (externally) by spatial deflection of the laser radiation (e.g. by means of an acousto-optical modulator) or by rotation of the polarization of the laser radiation (e.g. by means of a Pockels cell) by utilizing at least one polarization-dependent beam splitter and polarizer. In general, for the (external) generation of the laser pulses means can be provided, which upon application of an electric voltage or an electric current change their material properties and thereby transiently modulate the properties of laser radiation.

In the present case, “pulse laser” is understood to be a classical, intrinsically pulsed laser—in contrast to a so-called continuous-wave laser. A “pulsed laser” in the sense of the present invention need not be formed as such a pulse laser; but the corresponding laser pulses also can be generated by the external means explained above, wherein very short laser pulses with a pulse duration of not more than 5 μs should be made possible.

In contrast to the use of mechanical components for generating laser pulses, e.g. in the form of a so-called chopper, considerably shorter switching times are achieved in the present case. In this way, fluctuations of the total intensity of the laser pulses can be reduced distinctly, which substantially increases the reliability of the method.

The gas mixture in which the ¹⁴C isotope to be measured is contained as part of a molecule can be obtained in particular by chemical reaction from a sample whose ¹⁴C content should be determined. On the one hand, this can be effected by oxidation (combustion) of the sample, so that CO₂ is formed, with a corresponding content of ¹²CO₂, ¹³CO₂ and ¹⁴CO₂. In this case, ¹⁴CO₂ is detectable by means of laser light in particular with reference to characteristic stretching vibrations in a wavenumber range between 2000 cm⁻¹ and 2500 cm⁻¹. On the other hand, CH₄ (methane) can also be formed from the sample to be examined by treatment in a reduction chamber, wherein the ¹⁴C—H stretching vibrations of ¹⁴CH₄ at about 3000 cm⁻¹ provide for determining the ¹⁴C content.

To guide the pulsed laser beam a plurality of times through the measuring space filled with the gas mixture to be examined, deflection elements, e.g. in the form of an arrangement of radiation-reflecting elements, can be provided, which deflect the laser beam such that it moves between those deflection elements along at least one (e.g. circulating) path on which it passes through the measuring space by interacting with the gas mixture. The deflection elements each can be arranged inside or outside the measuring space.

It is provided that the laser radiation to be supplied to the measuring space is deflected in a polarization-dependent manner such that it passes through the measuring space a plurality of times by interacting with the gas mixture, and that the laser radiation subsequently is supplied to a detector in a polarization-dependent manner, in order to determine the absorption of laser radiation by the gas mixture.

In accordance with an exemplary development of the invention, the deflection elements are radiation-reflecting elements, whose reflecting properties are dependent on the polarization of the incident laser radiation. Thus, the deflection elements either can be transmissive for the laser radiation in dependence on the polarization or reflect and thereby effectively deflect the laser radiation.

To be able to couple in the laser beam into the region between the deflection elements in a defined manner, so that the laser beam is (continuously) moved along a path extending between those deflection elements in a defined manner by deflection at those deflection elements, and to be able to subsequently again couple the laser beam out of that region in a defined manner, so that it can be supplied to a detection means, there are provided means for coupling the laser beam in and out, which on coupling in and out preferably each couple at least 90% of the laser beam into and out of the region between the deflection elements.

In accordance with an exemplary embodiment of the invention, the laser beam is guided in the region between the deflection element for such a period that it covers a distance of at least 100 meters in the measuring chamber filled with the gas to be measured, before it is coupled out of that region.

The working range of the means for coupling the laser radiation in and out lies in the infrared range, and in particular in a wave trough range from 2000 cm⁻¹ to 4000 cm⁻¹.

The means for coupling the laser radiation in and out can be means for rotating the polarization of the laser radiation, namely in particular when the deflection elements, by means of which a laser beam coupled into the region between those deflection elements is deflected a plurality of times, are formed as radiation-reflecting elements whose reflecting properties are polarization-dependent. Laser radiation then on the one hand can selectively be coupled in into the region between the deflection elements by changing the polarization, for which purpose the polarization of the laser radiation is aligned such that the deflection elements for the laser radiation act as reflecting elements, and on the other hand be coupled out again, for which purpose the polarization of the laser radiation is rotated such that at least one deflection element now is transmissive for the laser radiation.

As means for coupling the laser radiation in and out, elements acting in the μs range preferably are used, such as for example a Pockels cell. This is an electrooptical component in which birefringence can be generated by an electric field. In this way, the polarization of (infrared) laser radiation can be rotated on short time scales.

As an alternative to a Pockels cell, an acousto-optical modulator (AOM) for example can be used for coupling the laser radiation in and out, which temporally deflects a passing laser beam by impulsive change of its material properties (e.g. of the density) and hence transiently changes the beam direction.

The used laser advantageously is a tunable (in terms of frequency) laser, so that for determining the ¹⁴C content in a gas mixture pulsed laser beams of different frequencies are successively emitted in short intervals, with each of which a certain range of the relevant part of the absorption spectrum of the gas mixture to be examined can be detected.

The laser advantageously is tunable in the subsecond range, so that a change from one frequency to the next is possible within periods of less than one second.

The line width of the laser radiation preferably is less than 0.3 cm⁻¹. The laser pulses generated by the laser each are coherent pulses.

As laser, a tunable pulsed infrared quantum cascade laser (QCL) can be used, for example.

In accordance with an exemplary development of the invention, a normalization of the signal to be detected with respect to the intensity fluctuations of the laser radiation is effected, which can be achieved for example in that a part of the laser radiation is coupled out before interaction with the gas mixture to be measured and utilized for normalizing the signal generated at the detector after interaction of the laser radiation with the gas mixture.

For noise suppression, a so-called heterodyne detection of the laser radiation can be provided, in that a part of the laser radiation is decoupled before interaction with the gas mixture and guided along a path which in the final analysis approximately leads to a path of the decoupled laser radiation of about equal length as the path along which the part of the laser radiation interacting with the gas mixture is guided. Before impinging on the detection means, the two parts of the laser radiation are superimposed again.

The detection of the laser radiation (after its interaction with the gas mixture to be measured) in particular can be effected by a so-called single-shot detection, in that the laser pulses are detected individually.

The evaluation of the detected radiation can be effected by reference to (biological) comparative or standard samples with known ¹⁴C content (referencing).

As a result of the determination of the ¹⁴C content of a sample either the ratio ¹⁴C/¹³C and/or the ratio ¹⁴C/¹²C or also the absolute quantity of the ¹⁴C isotope in the sample can be available.

The measurement in particular is effected with laser radiation in a spectral range between 2000 cm⁻¹ and 3200 cm⁻¹.

An arrangement for examining the composition of a gas mixture by means of laser radiation, which in particular is also suitable for carrying out the method for determining the ¹⁴C content in a gas mixture, is provided.

The arrangement comprises a radiation source in the form of a laser for emitting a laser radiation; a measuring space, in which the gas mixture to be examined is contained; a number of deflection elements, by means of which the laser radiation used for examining the gas mixture can be deflected such that it passes through the measuring space a plurality of times; and a detector means for detecting the laser radiation after its interaction with the gas mixture.

The laser here constitutes a pulsed laser which generates laser pulses with a pulse duration of less than 50 μs, in particular less than 5 μs or even less than 500 ns, and emits the same for examination of the gas mixture. And for coupling in the laser radiation into the region between the deflection elements as well as for later on coupling out the laser radiation from that region coupling means each are provided, whose working range—relative to the laser radiation to be coupled in and out—lies in the wavenumber range between 200 cm⁻¹ and 4000 cm⁻¹, and which each couple in and out at least 90% of the intensity of a currently applied laser radiation.

### BRIEF DESCRIPTION OF THE DRAWINGS

Further details of the invention will become apparent from the following description of two exemplary embodiments with reference to the Figures.

FIG. 1 shows a first exemplary embodiment of an arrangement for examining the composition of a gas mixture by means of laser radiation, in particular for detection of the ¹⁴C content.

FIG. 2 shows a modification of the arrangement of FIG. 1.

### DETAILED DESCRIPTION

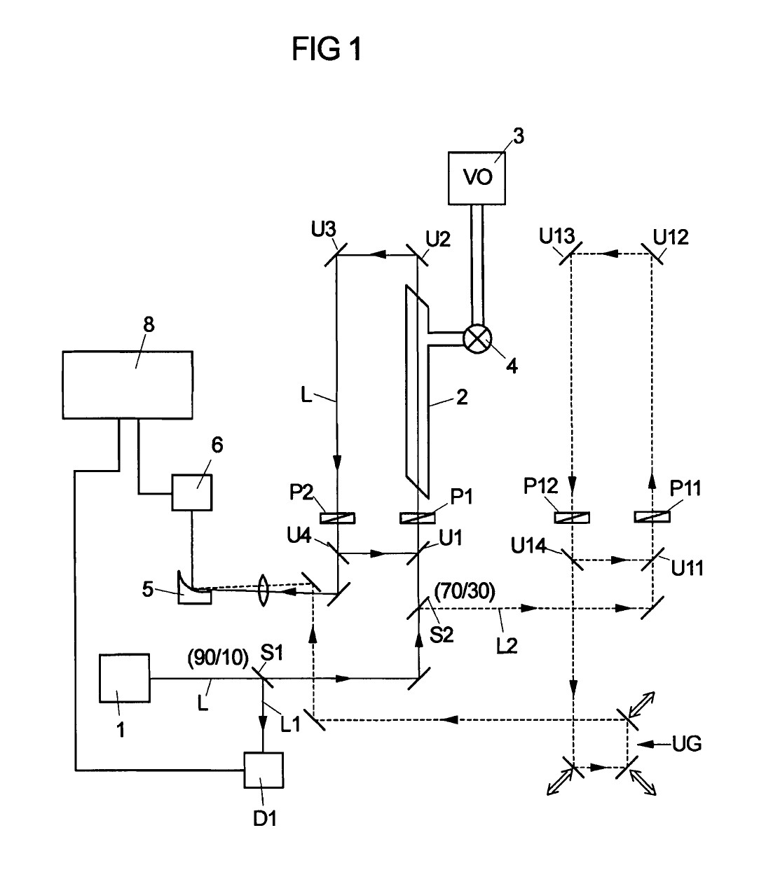

FIG. 1 shows an arrangement for determining the composition of a gas mixture, at least with regard to certain constituents of the gas mixture, such as a ¹⁴C content.

The arrangement comprises a laser 1, which is a pulsed laser which can generate ultrashort (coherent) laser pulses with a pulse duration of below 5 μs, in particular less than 500 ns, thus e.g. with a pulse duration in the nano-, pico- or femtosecond range. The laser 1 is suitable for generating infrared laser radiation, in particular in a spectral range with a wave number between 2000 cm⁻¹ and 3200 cm⁻¹.

The laser 1 can be e.g. a classical pulse laser which intrinsically is designed for generating (ultra-)short laser pulses, or also a combination of a continuous-wave laser (CW laser) with additional (external) means for generating such short (coherent) laser pulses, such as a Pockels cell or an acousto-optical modulator.

In the exemplary embodiment, the laser 1 is formed as a (quickly) tunable laser, and advantageously such that on tuning a change from one laser frequency to another laser frequency can be effected in the subsecond range, i.e. within distinctly less than one second. With such tunable laser (tunable in terms of the frequency or wavelength of the emitted radiation), laser radiation of different frequency or wavelength can be emitted one after the other within short time intervals (in the subsecond range), which each interacts with the gas mixture to be examined. As a result, the absorption behavior of the gas mixture at different frequencies or wavelengths can selectively be determined and thus an absorption spectrum can be generated. In the exemplary embodiment, the line width of the laser is below 0.3 cm⁻¹.

In concrete terms, a pulsed (e.g. in the nanosecond range) infrared quantum cascade laser (IR-QCL) can be used here as laser 1. Alternative types of laser include e.g. solid-state lasers (with difference frequency generation) or gas lasers.

After the laser 1 a first beam splitter S1 optionally is provided, with which a fraction L1, e.g. with an intensity of 10% of the original intensity of the laser beam L, can be coupled out from the laser beam L generated and emitted by the laser 1 and be supplied to an associated detector D1. With this detector D1 a fraction L1 of the laser radiation L is detected, which has not experienced any interaction with the gas mixture to be examined. The laser radiation L1 detected at the first detector D1 in particular can be used to perform a normalization of the measurement results achieved with the arrangement from FIG. 1 with respect to the intensity fluctuations of the laser radiation.

The (major) part of the (pulsed) laser radiation L emitted by the laser 1, which was not decoupled at the first beam splitter S1, is supplied as measuring beam to a deflection means comprising a plurality of deflection elements U1, U2, U3, U4, here by way of example four deflection elements, by means of which the laser beam L can be deflected such that it continuously circulates along one or more paths, wherein it each passes through a measuring space 2, here formed by a measuring chamber, in which a gas mixture to be examined is provided.

The deflection elements U1, U2, U3, U4 define a resonator space in which the laser radiation L is kept for a certain period, in order to provide for an interaction with the gas mixture to be examined in the measuring space 2 over this period. Before the deflection means U1, U2, U3, U4 a further beam splitter S2 optionally can be provided, whose function and importance will be explained in detail below.

In the present case, the deflection elements U1, U2, U3, U4 are formed as reflecting elements (resonator mirror), wherein at least in a part of the deflection elements the reflecting properties depend on the polarization of the incident laser radiation. In concrete terms, e.g. the first deflection element U1, on which the laser radiation L emitted by the laser 1 impinges first, is formed such that it is transmissive for the laser radiation L due to its current polarization, so that the laser radiation L passes through that first deflection element U1 into the region defined by the deflection elements U1, U2, U3, U4. Behind the first deflection element U1 a means P1 is arranged for coupling the laser radiation L into the deflection means U1, U2, U3, U4, which in the exemplary embodiment constitutes a Pockels cell. In general, this is e.g. a means for rotating the polarization of the laser radiation L, with which its polarization can be aligned such that the deflection elements U1, U2, U3, U4 each act as reflectors. As a consequence, the laser radiation L subsequently initially continuously circulates in the region (resonator space or chamber) defined by the deflection elements U1, U2, U3, U4, thereby repeatedly passing through the measuring space 2, in which the gas mixture to be examined is provided.

For coupling out the laser radiation L from the region defined by the deflection elements U1, U2, U3, U4, i.e. from the resonator chamber defined thereby, a means P2 for coupling out the laser radiation is provided, which in the present case is formed by a second Pockels cell. More generally, this is e.g. a means for rotating the polarization of the laser radiation L, by means of which the polarization of the laser radiation L can be rotated such that at least one of the deflection elements U1, U2, U3, U4, here the directly succeeding deflection element U4, becomes transmissive for the laser radiation L, so that the same can exit from the resonator space defined by the deflection elements U1, U2, U3, U4. In the present case, the deflection elements U1, U2, U3, U4—like the means P1, P2 for coupling in and out the laser radiation into the deflection means U1, U2, U3, U4—are located outside the measuring space 2 in which the gas mixture to be examined is provided. In principle, those elements U1, U2, U3, U4 can however also be arranged within that space 2, so that the laser radiation L is permanently present within that space 2, while it is deflected by the deflection elements U1 to U4. The same applies to the means P1, P2 for coupling the laser radiation L in and out.

Due to the fact that in the exemplary embodiment of FIG. 1 the deflection elements U1, U2, U3, U4 (and also the means P1, P2 for coupling the laser radiation L in and out) each are located outside the measuring space 2, the laser radiation L each only partly passes through the measuring space 2 in the region (resonator space) defined by the deflection elements U1, U2, U3, U4, wherein it interacts with the gas mixture to be examined.

The means P1, P2 for coupling the laser radiation L in and out are (electrically or optically) switchable or controllable, so that coupling the laser radiation in and out can be controlled selectively. Preferably, the laser radiation L, or more exactly a respective laser pulse of the pulsed laser 1, each remains within the resonator space, i.e. within the region defined by the deflection elements U1 to U4, for such a period that the laser radiation L or a respective laser pulse covers a distance of more than 100 m in the measuring space 2 due to the multitude of circulations within the region defined by the deflection elements U1, U2, U3, U4, wherein an interaction with the gas mixture present there each is effected. Depending on the conditions of the individual case, however, shorter distances (of less than 100 m) or particularly long distances (of more than 1 km) can also be provided.

In the exemplary embodiment, the gas mixture present in the measuring space 2 originates from a combustion furnace 3 in which a sample to be examined, in particular a sample to be examined for its ¹⁴C content, is oxidized (burnt), and which via suitable conveying means 4 is (directly) connected with the measuring space 2, here designed as measuring chamber, so that the gases generated on oxidizing/burning a sample in the combustion furnace 3 can be supplied to the measuring space 2 by means of those conveying means 4.

In the case of an organic sample which contains different carbon isotopes, in particular ¹²C, ¹³C and ¹⁴C, a gas mixture with corresponding constituents of ¹²CO₂, ¹³CO₂ and ¹⁴CO₂ is obtained by combustion. Thus, by determining the ¹⁴CO₂ content of the gas mixture present in the measuring space 2, the ¹⁴C content of the sample to be examined (for the purpose of age determination) and burnt in the combustion furnace 3 can be inferred.

After coupling out, the laser radiation L finally is supplied to a detector 6, which according to one embodiment can be equipped for a single-shot detection, i.e. for the detection of individual laser pulses.

By detecting the laser radiation L after interaction with the gas mixture to be examined, a range of the absorption spectrum of the gas mixture specified by the frequency or wavelength of the used laser radiation L can be determined, from which statements as to the composition of the gas mixture can be derived in a known way, in the present case in particular statements as to the content of certain constituents, such as the ¹⁴C content.

For evaluation, the signals (output signals) generated by the detector 6 as a result of the applied laser radiation L are supplied to an evaluation unit 8, which possibly is also connected with the optionally provided first detector D1 which detects a branched radiation fraction L1 which has not experienced an interaction with the gas mixture to be measured, which provides for a normalization of the measurement signals obtained at the main detector 6 with respect to the intensity fluctuations of the laser radiation.

For evaluating the signals supplied to the evaluation unit 8, known evaluation methods can be employed, for example those on the basis of cavity-ring down spectroscopy (CRDS), cavity enhanced absorption spectroscopy (CEAS), integrated cavity output spectroscopy (ICOS), cavity leak-out spectroscopy (CALOS) or noise-immune cavity enhanced optical heterodyne molecular spectroscopy (NICE-OHMS), see e.g. Welzel et al., Journal of Applied Physics, 104, (2008), 093115.

For noise suppression, a heterodyne detection of the laser radiation can be provided in accordance with one variant of the arrangement shown in FIG. 1. For this purpose, a fraction L2 of the laser radiation L (e.g. 30% relative to the radiation intensity) is coupled out with a (second) beam splitter S2 before the measuring space 2 and subsequently guided by means of a second deflection means U11, U12, U13, U14 and associated means P11, P12 for coupling in and out in the form of Pockels cells (or more generally in the form of means for changing the polarization of the radiation fraction L2 coupled out) over a distance of substantially equal, but variable length as the laser radiation L interacting with the gas mixture in the measuring space 2.

For varying the beam path (length of the distance), a group UG of deflection elements with adjustable position—corresponding to the double arrows in FIG. 1—can be provided.

Before the detection of the laser radiation L (after its multiple interaction with the gas mixture contained in the measuring space 2), a superposition of the laser radiation L with the branched radiation fraction L2 (which has not been brought to interact with the gas mixture, but substantially has covered the same distance) is effected by means of an optical component 5 (mixer) provided for this purpose.

As a result of a measurement carried out with the arrangement from FIG. 1, in particular of a determination of the ¹⁴CO₂ content of a sample converted into a gas mixture by chemical reaction (by irradiating the gas mixture with laser radiation), either the absolute quantity of the ¹⁴C isotope in the sample can be determined (from the ¹⁴CO₂ content in the gas mixture) or the relative concentration ¹⁴C/¹²C and/or ¹⁴C/¹³C (from the concentrations ¹⁴CO₂/¹²CO₂ or ¹⁴CO₂/¹³CO₂).

This is based on the scanning of certain absorption lines of ¹⁴CO₂ on the one hand and possibly of ¹³CO₂ and/or ¹²CO₂ on the other hand when tuning the laser frequency in the spectral range in which the relevant absorption lines are present, or via the spectral selection of a suitable broad spectral range of the laser radiation. The adjusted laser frequencies (when tuning the laser) or the selected spectral range follow the absorption lines of the stretching vibrations of CO₂, which lie in the infrared range between 2000 cm⁻¹ and 2500 cm⁻¹.

Storing the gas mixture to be examined in a measuring space 2 (in the form of a measuring chamber) provides for a temperature stabilization of the gas mixture and for repeated measurements for improving the signal-to-noise ratio. By increasing the effective path length during the interaction of the laser radiation L with the gas mixture to be examined as a result of the multiple passage through the measuring space 2, the measuring sensitivity is increased substantially.

For referencing the measurement result, a standard or comparative sample with a defined ¹⁴C content can be used, which in the arrangement as shown in FIG. 1—after combustion in the combustion furnace 3 by generating a gas mixture—is analysed by means of laser radiation in the same way as the sample to be examined, whose current ¹⁴C content must be determined. The comparison of the absorptivity A of ¹⁴CO₂ (possibly relative to the absorption of ¹³CO₂ or ¹²CO₂) in the sample to be examined with the corresponding absorption A^{S} of the comparative sample results in the decrease of the ¹⁴C content k of the sample to be examined as compared to a standard value specified by the comparative sample:

$$k = \frac{{A}_{{14}_{{CO}_{2}}} / {A}_{12 / {13}_{{CO}_{2}}}}{{A}_{{14}_{{CO}_{2}}}^{S} / {A}_{12 / {13}_{{CO}_{2}}}^{S}}$$

The decay of the ¹⁴C isotope is given by the function k(t)=k₀·e^{-t/τ}, wherein τ indicates the half-life period of the ¹⁴C isotope of 5730 years and k₀ can be put equal to 1 in a ratio measurement referenced to a standard sample. Hence it follows for the age t of the sample examined that t=−τ·ln k(t).

With a measurement accuracy of 1% on the measurement signal (detected laser radiation), age determinations accurate to 40 years hence can be achieved; and with a measurement accuracy of below 1‰ even accuracies in a one-year or -month term.

What should be considered here—as in all age determinations by means of the radiocarbon method—not only are possible adulterations as a result of the cleaning and processing of a sample, but also statistical fluctuations of the ¹⁴C/¹²C or ¹⁴C/¹³C ratio, and in particular systematic temporal fluctuations of those ratios, e.g. due to the influence of the industrialization on the ¹⁴C content in the atmosphere and due to uses and atmospheric tests of nuclear weapons in the period between 1943 and 1963. For these tests, methods for calibrating the radiocarbon method are available.

Temporal changes of the concentration of the carbon isotopes in the atmosphere can, however, also be utilized for age determination, in particular with recent (younger) samples, since the ¹⁴C content of living organisms depends on the ¹⁴C concentration in the atmosphere. As an example, the determination of the year or even month of birth of a human being with reference to the ¹⁴C concentration in the eye lenses should be mentioned. The human eye lens contains transparent proteins (crystallines), which are preserved in their original structure from their formation in the eye. Therefore, they can be regarded as a mirror image of the atmospheric concentration of the individual carbon isotopes at the time of their formation, which takes place shortly after the birth of a human being. The later a human being has been born after entry into force of the Treaty to Ban Atmospheric Tests of Nuclear Weapons in the year 1963, the lower the content of the ¹⁴C isotope in the eye lenses.

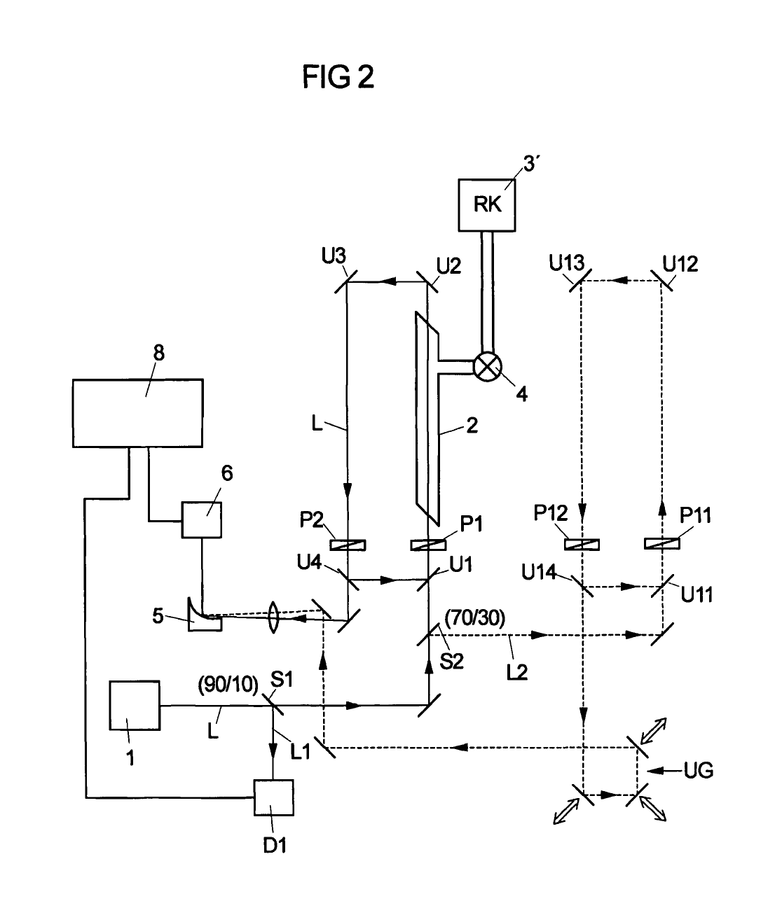

A modification of the arrangement of FIG. 1 is shown in FIG. 2, with the essential difference consisting in that the gas mixture to be brought to interact with the laser radiation L (i.e. the measuring beam) is not generated by combustion of the sample to be examined in a combustion furnace; but according to FIG. 2 a reduction chamber 3′ rather is provided, in which the sample to be examined is quickly heated to about 2000° C. in a hydrogen stream for generating a gas, wherein the carbon atoms of the sample react to form methane and the oxygen atoms react to form water. The hydrogen stream also can act as carrier gas for transferring the resultant gas mixture, in particular comprising methane (CH₄ with the isotopes ¹²CH₄, ¹³CH₄ and ¹⁴CH₄), into the measuring space 2.

For determining the ¹⁴CH₄ content in the gas mixture (and hence of the ¹⁴C content in the sample converted to the gas mixture) or especially for determining the ratio ¹⁴CH₄/¹²CH₄ or ¹⁴CH₄/¹³CH₄, the absorption due to the C—H stretching vibrations in the wavenumber range of 3000 cm⁻¹ can be used, which have different wavenumbers for the individual isotopes ¹²C, ¹³C and ¹⁴C, cf. D. Kleine, H. Dahnke, W. Urban, P. Hering and M. Mürtz, Optics Letters 25, pp. 1606-1608 (2000).

Both exemplary embodiments are based on the precise determination of the ¹⁴C content of a sample with a laser-spectroscopic measurement method in the infrared spectral range by using a pulsed laser which acts on a gas generated from the sample to be examined, in which the ¹⁴C isotope is present as constituent of a molecule, such as CO₂ or CH₄.

With the used measurement method, the intensity of the molecule vibrations relevant in the respective individual case, such as the asymmetric ¹⁴CO₂ and possibly ¹³CO₂ and/or ¹²CO₂ stretching vibrations, can be measured in the infrared range in an almost background-free and molecularly dissolved manner. Cooling below −40° C. is not required.

This highly accurate detection method in turn provides for precise age determinations (datings) of a sample to be examined, which also results in new applications and perspectives for the radiocarbon method: While the same presently is chiefly used for age determination in archeological finds, it is now also possible to examine recent samples in which the ¹⁴C content still is relatively high. As an example, the use of the method in forensic analysis should be mentioned. For example, when the time of death of a strongly decomposed corpse no longer can be determined entomologically, the radiocarbon method presented here at least allows to determine the month or year of the time of death. Likewise, the year of birth of a human being can be determined with reference to the ¹⁴C content of a human eye lens, and in particular for persons born after 1963.

Another example is the dating of art objects, such as rare relics, ancient paintings and valuable antiques, in order to distinguish originals from forgeries. Further advantages of the laser-spectroscopic measurement method for determining the ¹⁴C content of a sample are the lower space requirement and the distinctly lower acquisition costs as compared to an acceleration mass spectrometer.

1. A method for determining the ¹⁴C content of a gas mixture in which ¹⁴C isotopes are present as molecule constituents, wherein
the gas mixture is provided in a measuring space,
infrared laser radiation is supplied to the measuring space as measurement radiation,
the laser radiation to be supplied to the measuring space is deflected such that it passes through the measuring space a plurality of times by interacting with the gas mixture, and
the laser radiation is supplied to a detector, in order to determine the absorption of laser radiation by the gas mixture and therefrom determine the ¹⁴C content, and
for generating the laser radiation a pulsed laser is used, which as measurement radiation emits laser pulses with a pulse duration of less than 5 μs, which are supplied to the measuring space.

2. The method according to claim 1, wherein for generating the laser radiation a pulsed laser is used, which as measurement radiation emits laser pulses with a pulse duration of less than 500 ns.

3. The method according to claim 1, wherein the laser pulses are generated by means which by application of an electric voltage or an electric current change their material properties and thereby transiently modulate the properties of laser radiation.

4. The method according to claim 1, wherein the gas mixture provided in the measuring space is generated by chemical reaction from a sample containing ¹⁴C isotopes.

5. (canceled)

6. (canceled)

7. The method according to claim 1, wherein the laser radiation is deflected by means of deflection elements, in particular in the form of reflecting elements, such that the laser radiation propagates between the deflection elements and in doing so at least partly passes through the measuring space a plurality of times.

8. The method according to claim 7, wherein as deflection elements at least partly radiation-reflecting elements are used, whose reflecting effect depends on the polarisation of the incident laser radiation.

9. The method according to claim 7, wherein means are provided for coupling in and/or out the laser radiation into and out of the region between the deflection elements.

10. The method according to claim 9, wherein the means for coupling in and/or out are equipped to each couple in or out at least 90% of the intensity of the incident laser radiation.

11. The method according to claim 9, wherein the means for coupling the laser radiation in and/or out are active in a wavenumber range between 2000 cm⁻¹ and 4000 cm⁻¹.

12. The method according to claim 9, wherein the means for coupling the laser radiation in and/or out constitute means for rotating the polarization of the laser radiation.

13. (canceled)

14. (canceled)

15. (canceled)

16. The method according to claim 1, wherein the laser emits coherent laser pulses with a pulse duration of less than 5 μs, in particular less than 500 ns.

17. (canceled)

18. (canceled)

19. (canceled)

20. (canceled)

21. The method according to claim 1, wherein before the interaction of the laser radiation serving as measurement radiation with the gas mixture, a radiation fraction is decoupled, which propagates without interaction with the gas mixture and which before the detector is superimposed on the laser radiation serving as measurement radiation.

22. (canceled)

23. (canceled)

24. (canceled)

25. (canceled)

26. (canceled)

27. (canceled)

28. An arrangement for examining the composition of a gas mixture with regard to at least one constituent, comprising
a laser for emitting infrared laser radiation,
a measuring space for providing a gas mixture to be examined,
a number of deflection elements by means of which the laser radiation can be deflected such that it propagates in the measuring space a plurality of times in different directions, and
a detector for detecting the laser radiation after its interaction with a gas mixture provided in the measuring space,
wherein the laser constitutes a pulsed laser which generates and emits laser pulses with a pulse duration of less than 5 μs as laser radiation, and that means are provided for coupling in the laser radiation into the region between the deflection elements and for coupling out from that region, whose working range—based on the wave number of laser radiation to be coupled in and out—lies between 200 cm⁻¹ and 4000 cm⁻¹.

29. The arrangement according to claim 28, wherein the laser constitutes a pulsed laser which generates and emits laser pulses with a pulse duration of less than 500 ns as laser radiation.

30. The arrangement according to claim 28, wherein for generating the laser pulses means are provided, which by application of an electric voltage or an electric current change their material properties and thereby transiently modulate the properties of laser radiation.

31. (canceled)

32. The arrangement according to claim 31, wherein as deflection elements at least partly radiation-reflecting elements are used, whose reflecting effect depends on the polarization of the incident laser radiation.

33. The arrangement according to claim 28, wherein the means for coupling the laser radiation in and out are formed such that they couple in and/or out at least 90% of the intensity of an applied laser radiation.

34. The arrangement according to claim 28, wherein the means for coupling the laser radiation in and/or out are formed as means for rotating the polarization of the laser radiation.

35. The arrangement according to claim 34, wherein as means for coupling the laser radiation in and/or out at least one Pockels cell is provided.

36. The arrangement according to claim 28, wherein as means for coupling the laser radiation in and/or out an apparatus is provided, which by changing its material properties changes the beam direction of the laser radiation on a time scale of not more than 500 ns.

37. (canceled)

38. The arrangement according to claim 28, wherein the laser emits coherent laser pulses with a pulse duration of less than 5 μs, in particular less than 500 ns.

39. (canceled)

40. (canceled)

41. The arrangement according to claim 38, wherein before the interaction of the laser radiation serving as measurement radiation with the gas mixture, a radiation fraction is decoupled, which propagates without interaction with the gas mixture and which before the detector is superimposed on the laser radiation (L) serving as measurement radiation.

42. (canceled)

43. (canceled)

44. The method according to claim 1, wherein the ¹⁴C content is determined by determination of the ration ¹⁴C/¹²C and or the ration ¹²C/¹⁴C.
